(19) United States
(12) Patent Application Publication
(10) Pub. No.: US 2026/0101126 A1
(43) Pub. Date: Apr. 9, 2026

(54) IMAGING SENSOR DEVICE USING AN ARRAY OF SINGLE-PHOTON AVALANCHE DIODE PHOTODETECTORS

(71) Applicant: Ecole Polytechnique Federale De Lausanne (EPFL), Lausanne (CH)

(72) Inventors: Andrei ARDELEAN, Neuchâtel (CH); Edoardo CHARBON, JOUXTENS-MEZERY (CH)

(73) Assignee: Ecole Polytechnique Federale De Lausanne (EPFL), Lausanne (CH)

(21) Appl. No.: 19/120,742

(22) PCT Filed: Oct. 13, 2022
(86) PCT No.: PCT/EP2022/078539

§ 371 Date: Apr. 11, 2025

(51) Int. Cl. H04N 25/773; H04N 25/76; H04N 25/79

(52) U.S. Cl. CPC H04N 25/773; H04N 25/7795; H04N 25/79

(57) ABSTRACT

The invention relates to an Imaging sensor device in a stacked arrangement comprising:
a pixel array tier comprising a plurality of pixel segments each having a plurality of pixels for photon detection each providing a digital pixel output;
a processing tier comprising a number of processing cores each associated with one of the plurality of pixel segments to receive the pixel outputs of the pixels of the respective pixel segment, wherein the processing cores are each in bidirectional communication with one or more neighboring processing cores,
   wherein the processing cores are each configured to receive pixel outputs of the pixels of the associated pixel segments and to distribute processing of pixel outputs between the processing core and the at least one of the neighboring processing cores as neighboring processing cores.

### TECHNICAL FIELD

The present invention relates to imaging sensor devices, particularly to imaging sensor devices using photon detection with single photon avalanche diodes, and having improved and configurable image data processing flexibility.

### TECHNICAL BACKGROUND

In general, imaging sensor devices include a two-dimensional array of photodetectors. Photodetectors may be configured to detect one to multiple impinging photons and provide a corresponding photon detection signal to generate image information of a received light distribution. One kind of photodetectors include a single-photon avalanche diode (SPAD) which is configured to detect light upon photon detection by generating an electron-hole pair and multiplying it through an electrical field which produces a detectable avalanche of electrons.

Such so-called Geiger mode photodetection cells are usually fabricated on/in a silicon substrate having a p-n junction electrically biased beyond its breakdown voltage such that each electron-hole pair can trigger an avalanche multiplication process forming a photon detection signal as an electrical pulse signal.

After recognizing such an avalanche, the avalanche is quenched by reducing the electrical field which accelerated the generated electrons so that the avalanche process is stopped. Thereafter, the electrical field is increased again to make the photodetection cell ready for a next photon detection.

Document U.S. Pat. No. 9,210,350 discloses an imaging system, comprising a pixel array including a plurality of pixels, wherein each one of the plurality of pixels includes a single photon avalanche diode (SPAD) coupled to detect photons in response to incident light. A plurality of photon counters is included in a readout circuitry, wherein each one of the plurality of photon counters is coupled to a respective one of the plurality of pixels to count a number of photons detected by said respective one of the plurality of pixels. Each one of the plurality of photon counters is coupled to stop counting photons for said respective one of the plurality of pixels that reaches a threshold photon count, and wherein each one of the plurality of photon counters is coupled to continue counting photons for said respective one of the plurality of pixels that does not reach the threshold photon count. A control circuitry is coupled to the pixel array to control operation of the pixel array and includes an exposure time counter coupled to count an exposure time elapsed before each one of the plurality of pixels detects the threshold photon count. Respective exposure time counts and photon counts are combined for each one of the plurality of pixels of the pixel array.

Document A. C. Ulku, C. Bruschini, I. M. Antolovic et al., “A 512×512 SPAD image sensor with integrated gating for widefield FLIM”, IEEE Journal of Selected Topics in Quantum Electronics, vol. 25, no. 1, pp. 1-12, 2019 discloses an image sensor with 512×512 photon-counting pixels, each comprising a single-photon avalanche diode (SPAD), a 1-bit memory, and a gating mechanism capable of turning the SPAD on and off. The sensor is designed to achieve a high frame rate.

Document K. Morimoto, A. Ardelean, M.-L. Wu, et al., “Megapixel time-gated SPAD image sensor for 2D and 3D imaging applications”, Optica, vol. 7, no. 4, pp. 346-354, 2020 discloses an 1 Mpixel single-photon avalanche diode camera featuring 3.8 ns time gating and 24 kfps frame rate.

Document C. Zhang, S. Lindner, I. M. Antolovic, M. Wolf, and E. Charbon, “A CMOS SPAD imager with collision detection and 128 dynamically reallocating TDCs for single-photon counting and 3D time-of-flight imaging”, Sensors, vol. 18, no. 11, 2018 discloses a single-photon avalanche diode (SPAD) sensor with a per-pixel time-to-digital converter (TDC) architecture to achieve high photon throughput. A SPAD sensor with 32×32 pixels is disclosed fabricated with a 180 nm CMOS image sensor technology, where dynamically reallocating TDCs were implemented to achieve the same photon throughput as that of per-pixel TDCs. Each 4 TDCs are shared by 32 pixels via a collision detection bus.

Document S. Lindner, S. Pellegrini, Y. Henrion, B. Rae, M. Wolf, and E. Charbon, “A high-PDE, backside-illuminated SPAD in 65/40-nm 3D IC CMOS pixel with cascaded passive quenching and active recharge”, IEEE Electron Device Letters, vol. 38, no. 11, pp. 1547-1550, 2017 discloses a detector pixel based on a single-photon avalanche diode (SPAD) fabricated in a backside-illuminated (BSI) 3D IC technology. The chip stack comprises an image sensing tier produced in a 65-nm image sensor technology and a data processing tier in 40-nm CMOS. Using a simple, CMOS-compatible technique, the pixel is capable of passive quenching and active recharge at voltages well above those imposed by a single transistor whilst ensuring that the reliability limits across the gate-source (VGS), gate-drain (VGD) and drain-source (VDS) are not exceeded for any device.

It is an object of the present invention to provide an improved architecture for an imaging sensor device having a stack with an image sensing tier and a data processing tier offering broad configurable operation modes for efficient processing.

### SUMMARY OF THE INVENTION

This object has been achieved by the imaging sensor device of claim 1. Further embodiments are indicated in the depending subclaims.

According to a first aspect an imaging sensor device in a stacked arrangement is provided comprising:
a pixel array tier comprising a plurality of pixel segments each having a plurality of pixels for photon detection each providing a digital pixel output;
a processing tier comprising a number of processing cores each associated with one of the plurality of pixel segments to receive the pixel outputs of the pixels of the respective pixel segment, wherein the processing cores are each in bidirectional communication with one or more neighboring processing cores,
   wherein the processing cores are each configured to receive pixel outputs of the pixels of the associated pixel segments and to distribute processing of pixel outputs between the processing core and the at least one of the neighboring processing cores.

The above imaging sensor device is a reconfigurable and scalable computational imaging sensor which has fully autonomous processing capabilities provided by processing cores. The flexibility of the architecture stems from the ability to run custom programs/algorithms in each processing core but also from the re-configurable hardware at the pixel interface that can be customized through software at runtime.

Moreover, the pixels of the pixel array tier may comprise a detector diode, particularly an SPAD, and a preprocessing circuitry coupled with the detector diode to provide the respective pixel output as a signal, wherein particularly the signal may be provided to the processing tier e.g. via through vias the pixel array tier. The pixel array tier is provided on a semiconductor (e.g. silicon) substrate which is processed by semiconductor processing technologies to produce the structures of the pixels and the preprocessing circuitry.

The processing tier may also be provided on a semiconductor (e.g. silicon) substrate which is processed by semiconductor processing technologies to produce the structures of the pixels and the preprocessing circuitry.

According to an embodiment, each processing core may comprise a front end block that may comprise a combinational logic and/or at least one lookup table which are freely configurable to provide masking and/or logical operations for the pixel outputs to preprocess and/or combine the pixel outputs.

It may be provided that a timing block is configured to receive the preprocessed pixel outputs and to perform various timing functions as known in the art, such as pulse width and/or phase shift measurements.

Moreover, a processing block in each of the processing cores may be provided comprising a set of general purpose registers, an arithmetic and logic unit (ALU), a RAM and a control block to provide flexible data processing capabilities wherein the control block is configured to control the data processing operation of the processing block.

Particularly, the control block of at least one processing core associated with one pixel segment may be configured to split one or more processing tasks to be performed on the pixels of that one pixel segment into processing parts wherein at least two of the processing parts may be processed in parallel at a time, wherein the at least two parallelly processable processing parts are performed in the processing core and the at least one neighboring processing cores by directly controlling processing of the respective processing part in the processing block of the processing core and by instructing the at least one neighboring processing core to perform the other of the respective processing parts, respectively.

According to an embodiment, the processing task may be a LSTM calculation performed on an image detected by the imaging sensor device, wherein the LSTM calculation includes matrix operations, addition operations, sigmoid operations and tangens hyperbolicus operations, wherein the control blocks of each of the processing cores may each be configured
to split the execution of the matrix operations and addition operations to be performed on the pixels of that one associated pixel segment into multiple processing parts,
to perform at least one of the multiple processing parts in the respective control block, and
to communicate at least one of the multiple processing parts to at least one of the neighboring processing cores and to instruct the at least one neighboring processing core to perform the respective at least one of the multiple processing parts.

### BRIEF DESCRIPTION OF THE DRAWINGS

Embodiments are described in more detail in conjunction with the accompanying drawings, in which:

FIG. 1 shows a top view of an imaging sensor device;

FIG. 2 shows a cross-sectional view through the imaging sensor device.

FIG. 3 shows a circuit diagram of a pixel circuitry of the pixel array tier.

FIG. 4 schematically shows the pixel layout.

FIG. 5 shows a close-up top view on an edge of the processing tier substrate.

FIG. 6 shows the block diagram of a processing core.

FIG. 7 shows a schematic of the reconfigurable front-end circuit block.

FIG. 8 shows the group arrangement of the pixel outputs associated to a LUT.

FIG. 9 shows the schematics of a timing block implemented in each processing core.

FIG. 10 shows a processing block implemented in each processing core.

FIG. 11 shows an architecture of the imaging sensor device comprising a number of processing cores arranged in a grid.

FIG. 12 presents a scheduled graph for equations of realizing an LSTM inference operation.

FIG. 13 shows the exemplary arrangement of the 5 processing cores with one master and four slave processing cores.

### DETAILED DESCRIPTION OF EMBODIMENTS

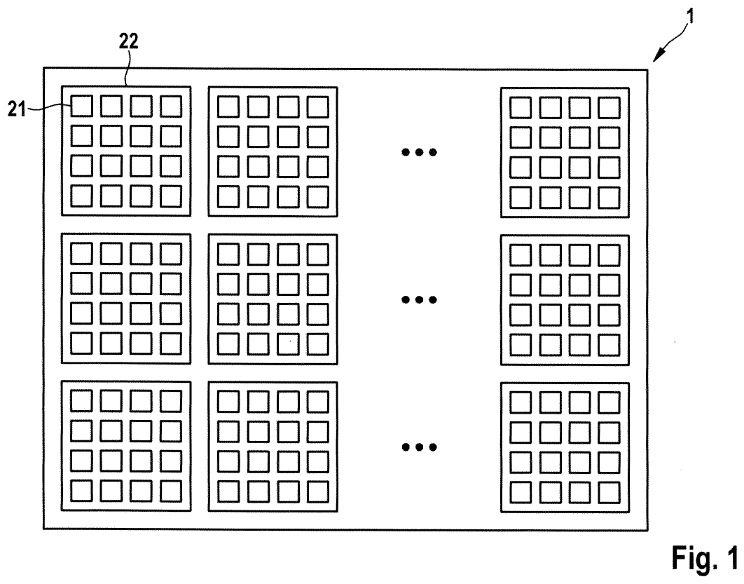

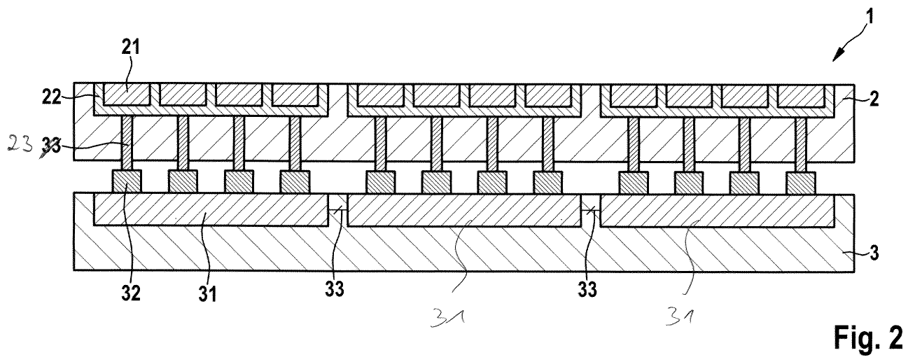

FIG. 1 shows a top view onto an imaging sensor device 1 and FIG. 2 a cross-sectional view through an imaging sensor device 1 having a stack of a pixel array tier 2 and a processing tier 3. Both tiers 2,3 may be manufactured in CMOS technology and/or FinFET 3D technology in e.g. silicon substrates.

The pixel array tier 2 may be an exemplary 12×24 array (or any other size) of SPAD pixels 21 (SPAD: Single Photon Avalanche Diodes) grouped into pixel segments 22 of 4×4 SPAD pixels. Every pixel output is electrically connected to the processing tier 3 with a through-substrate via (TSV) 23.

The processing tier 3 has a 3×6 array of independent processing cores 31 each connected with the SPAD pixels 21 of a respective pixel segment 22. The processing cores 31 can share information and exchange data with their direct neighboring processing cores 31 and can synchronize with each other through the use of internal and external handshaking signals. The processing tier 3 was designed for 3D integration with large TSV landing sites 32 similar in structure to traditional flip-chip ball bonding pads.

The processing tier 3 contains digital processing electronics and processes the pixel array raw data of the pixel array tier 2 (including the pixel outputs of each SPAD pixels 21) as the front-end. Such a stacked architecture offers the possibility of using the processing tier 3 as a generic readout IC coupled with custom detector technologies not limited to SPAD-based pixel arrays.

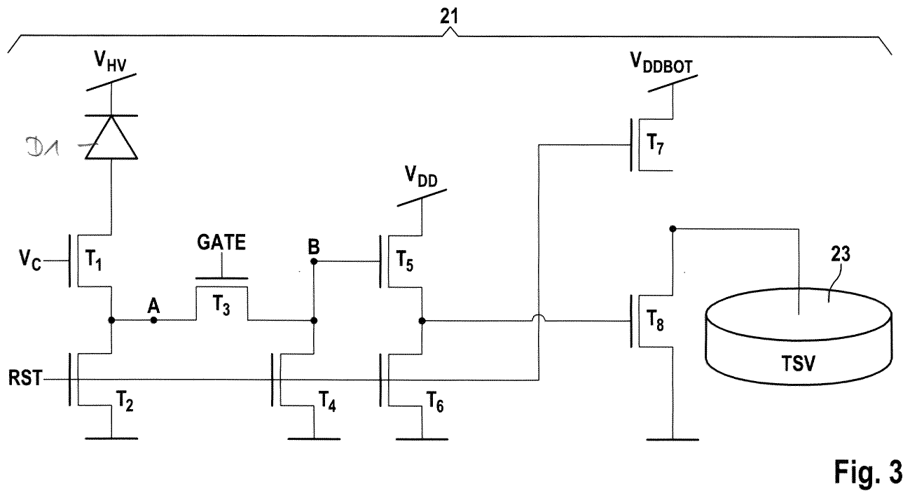

FIG. 3 shows a circuit diagram of an exemplary pixel schematic as an electronic circuitry of the pixel array tier 2. A detector diode D1, such as an SPAD, is in series with a cascode transistor T1 and a reset transistor T2 between a high voltage potential V_{HV} and a ground potential GND. The cascode transistor T1 is used to extend the bias voltage range of the pixel while the reset transistor T2 implements the clock-driven active recharge controlled by a provided RST signal.

When an avalanche takes place, the voltage at a node A between the transistors T1 and T2 will rise and depending on the state of a gate transistor T3 which is coupled to node A as a transmission gate, can act on node B and a gate of transistor T5. If level of node B is high, the transistor T5 will drive the gate of oversized (thick oxide) transistor T8 that discharges the large parasitic capacitance of the TSV 23. The RST signal also drives transistor T4 coupled to node B to reset node B, transistor T6 coupled in series with transistor T4 and transistor T7 in series with transistor T8 to recharge the capacitance of the TSV 23. Voltage level translation may be achieved by setting a supply voltage VDDBOT e.g. to 0.8 V plus the threshold voltage of the transistor T8.

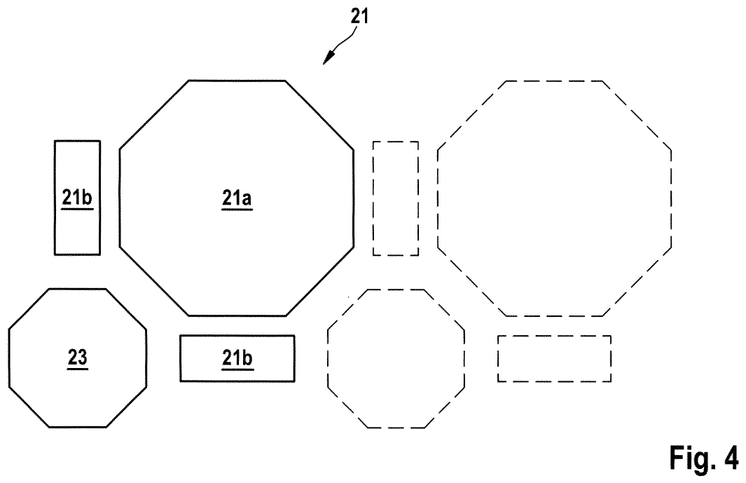

FIG. 4 schematically shows the pixel layout. The detector diode 21a is in the center of the pixel area. The octagonal shape at the bottom left is the metal contact for the TSV 23. All the pixel circuitry is located in the bottom and left side rectangular sections 21b. Due to the small area and spacing requirements, all of the transistors may be formed as thick oxide NMOS to circumvent minimum spacing rules between transistors of different types. A pixel area of a neighboring pixel is indicated with dotted lines.

The processing tier 3 may accommodate TSV landing sites 32 which may be formed by rectangular aluminum contacts in groups of 16 to the underlying processing cores 31 through a set of ESD protection diodes (not shown). The TSV landing sites 32 are to receive pixel outputs.

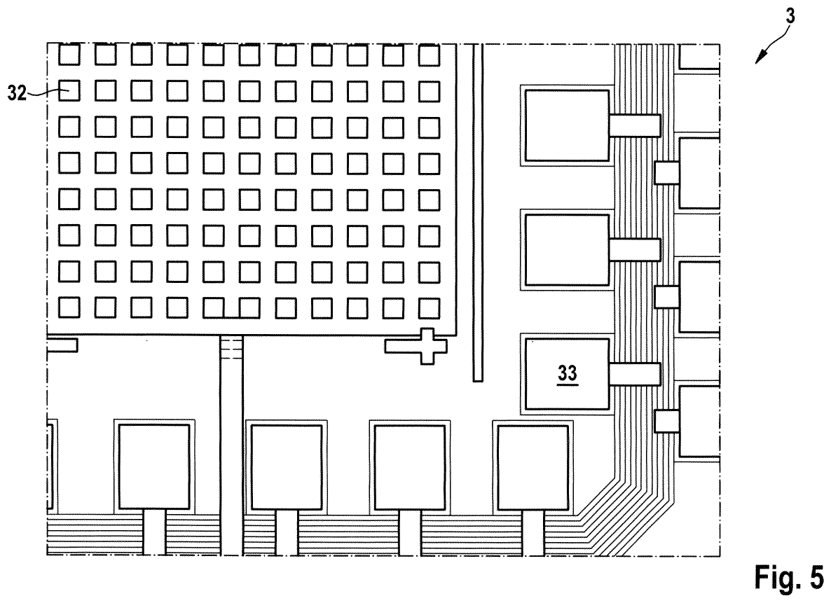

FIG. 5 shows a close-up top view on an edge of the processing tier substrate, where the TSV landing sites 32 can be seen next to the normal size bonding pads 33 for external connection of the imaging sensor device 1.

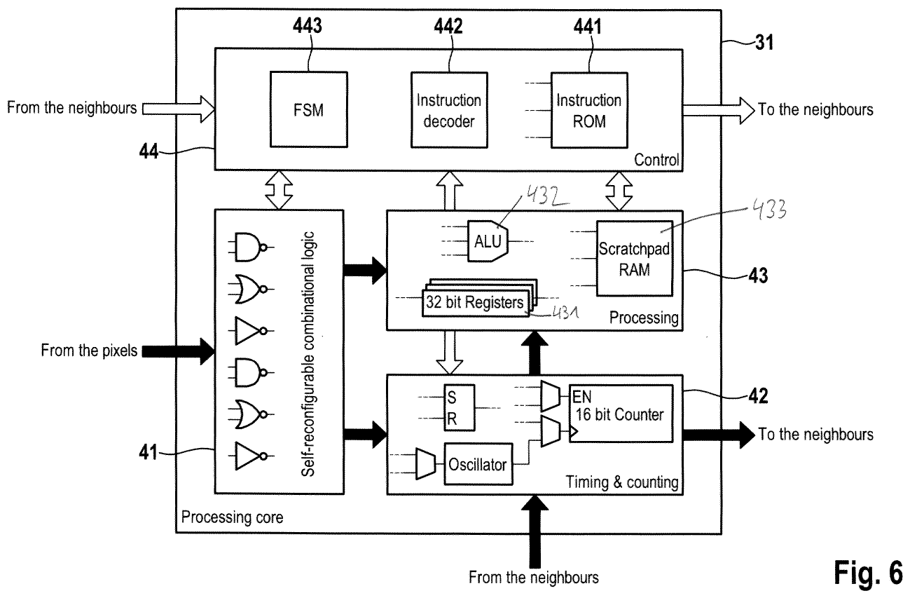

FIG. 6 shows the block diagram of a schematic of a processing core 31. Each processing core 31 is connected to 16 pixels on the pixel array tier 2 arranged in a 4×4 pixel pattern. The pixel output signals (pixel outputs) coming from the pixel circuitry on the pixel array tier 2 connect to a reconfigurable front end block 41 that comprises a combinational logic and lookup tables (LUT).

The front end circuit block 41 can preprocess the pixel output data before it is transferred to a timing block 42 and/or a processing block 43. The timing block 42 is a specialized circuit that can perform various timing functions such as pulse width or phase shift measurements.

The processing block 43 is a set of general purpose registers 431, an arithmetic and logic unit (ALU) 432 and a RAM 433. The entire operation of the processing core 31 is coordinated by a control block 44, where an instruction ROM 441 and an instruction decoder 442 may be contained which define the operation of the processing block 43.

The control block 44 can receive inputs from neighboring processing cores 31 and can in turn provide software controlled outputs used for synchronization. Similarly, timing block 42 can receive inputs from the neighboring processing cores 31 and can provide fast propagating signals through dedicated channels, e.g. external of the device by way of other processing cores 31.

The synchronization works for the front end block 41 and the timing block 42 by implementing dedicated signal paths (1 bit wires) through which the output of the front end or the timing module can be routed to the front end and/or timing blocks. So, the timing block 42 of all the neighboring processing cores 31 can be triggered by a detection of the same photon by the master. In this case, the output of the front end circuit blocks 41 of the master processing cores 31 will be routed to all four neighboring processing cores 31 through a multiplexer and they can treat it as if it came from their own front end circuit block 41 (of the slave processing core 31).

If more than 16 bit of range for the timing block 42 is needed, the most significant bits of the timing block 42 can be routed to a timing block 42 of a neighboring processing core 31 and used as a counter clock there, practically using two separate 16 bit counters as a single 32 bit one.

The synchronization signals are generated by the control block 44 as simple 1 bit signals that come from the neighboring processing cores 31 which can be checked using conditional instructions in the code. For example, jump to line XX if neighboring processing core 31 has sent a signal. There are also dedicated instructions to emit a signal to a specific neighboring processing core 31, for example a strobe signal for a neighboring processing core 31.

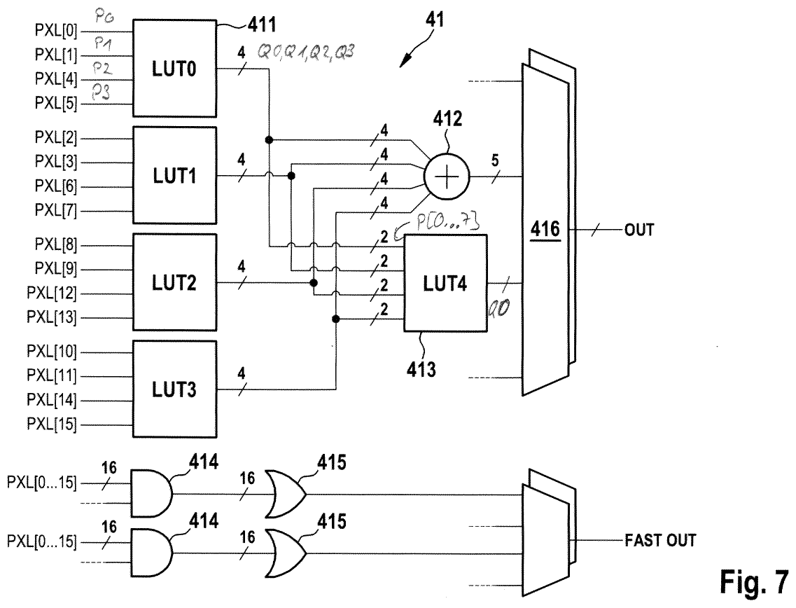

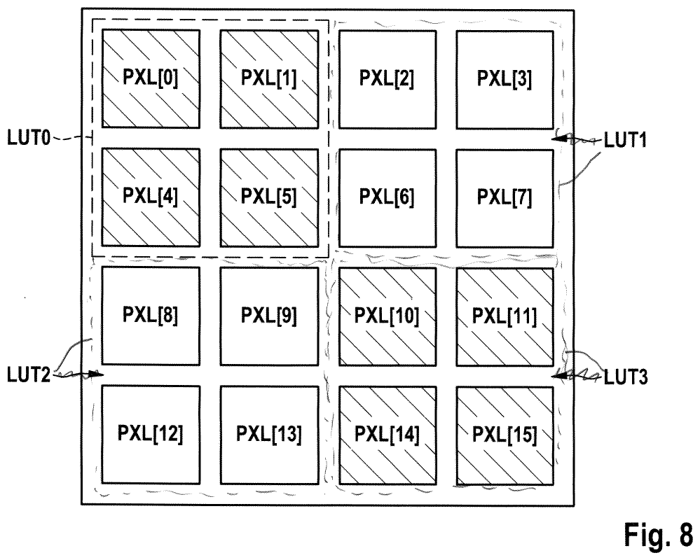

FIG. 7 shows the schematic of the reconfigurable front end circuit block 41. Sixteen pixel outputs PXL[0 . . . 15] are connected to a group of 4 LUTs 411 (LUT0 to LUT3) in groups of 4 according to the diagram shown in FIG. 8. The purpose is to create the possibility of binning the 4×4 pixels into groups of 2×2. Each LUT can be programmed by the control block 44 using 4 instruction cycles to implement any logic function of the type:

$$Q 3 Q 2 Q 1 Q 0 = a [ 0 ] P 3 P 2 P 1 P 0 + a [ 1 ] P 3 P 2 P 1 P 0 + … + a [ 15 ] P 3 P 2 P 1 P 0$$

where P and Q are the 4 bit LUT input and output, respectively, and all is an array of 16 values of 0 and 1.

The outputs of the first layer of LUTs LUT0, LUT1, LUT2, LUT3 are connected to a secondary layer of circuits comprising of an adder 412 and LUT4 413. The adder sums together the 16 bits of the outputs Q of the LUTs 411 into a single 5 bit number, essentially counting the number of 1s. LUT4 is a larger version of the other 4, having an 8 bit input and a 1 bit output. Contrary to the adder, only the most significant two bits from the outputs of the previous LUTs 411 are connected to it.

LUT4 can also be configured by the control block 44 in 16 instruction cycles to implement any function of the type:

$$Q 0 = a [ 0 ] P 7 P 6 P 5 P 4 P 3 P 2 P 1 P 0 + a [ 1 ] P 7 P 6 P 5 P 4 P 3 P 2 P 1 P 0 + ⋯ + a [ 255 ] P 7 P 6 P 5 P 4 P 3 P 2 P 1 P 0$$

where P is the 8 bit input assembled by 2 bits of the outputs of the LUTs 411, Q is the 1 bit output and a is an array of 256 values of 0 and 1.

The 16 pixel outputs connect to two OR trees 414 and can be individually masked using a set of AND gates 415. This secondary path is designed with a separate set of constraints to allow for fast signal propagation and can serve as inputs to the timing block 42 or the other neighboring processing cores 31.

Various signals from the front end circuit block 41 such as but not limited to the LUT and adder outputs and raw pixel values are connected to an output DMUX 416 that, like all the other circuits, may be controlled by the control block 44. This results in a software flexibility to select various pre-processed versions of the inputs without the need to reconfigure the front end circuit block 41.

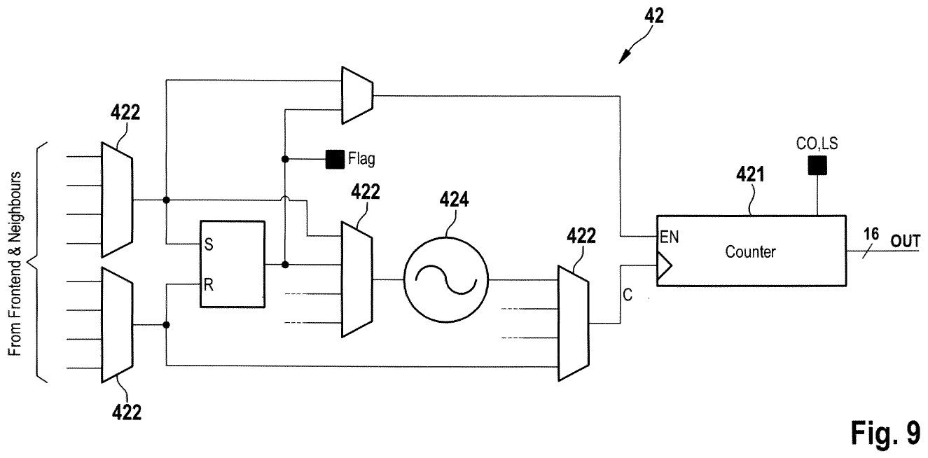

FIG. 9 shows the schematics of the timing block 42 implemented in each processing core 31. A 16 bit counter 421 serves as the central element of the timing block 42, with its value used as the timing block output. A set of multiplexers 422 are used to select which sources act as the counter clock signal C and enable signal EN with a wide selection available for both cases. Inputs to the multiplexers 422 may be the fast output signal of FIG. 7. The counter clock signal and the enable signal may be selected from the front-end block 41 in various manners.

The enable signal EN can be sourced directly from the front end circuit block outputs or through a SR latch 423 which can combine two separate input signals of the front end outputs. In addition, pulses generated by neighboring processing cores 31 or the control block 44 can be used as counter clock signal C or enable signal EN.

A local oscillator 424 may be formed by a ring of a number of (e.g. 7) NAND gates and can be used to generate a higher frequency clock reference for the counter.

The timing block 42 generates two flags that can be used by the control block 44 for conditional instructions: a counter overflow CO and a latch set LS. The counter overflow CO is set when an overflow is detected in the counter 421 and is essentially a latched 17th counter bit. The latch set LS is the state of the input SR latch and can be used to detect the arrival of an input.

The control block 44 is capable of reconfiguring the functionality of the timing block 42 by setting all the multiplexers 422 and resetting the counter 421 and the two flags CO, LS. A full reconfiguration requires two instruction cycles but for the majority of cases, a single cycle will suffice.

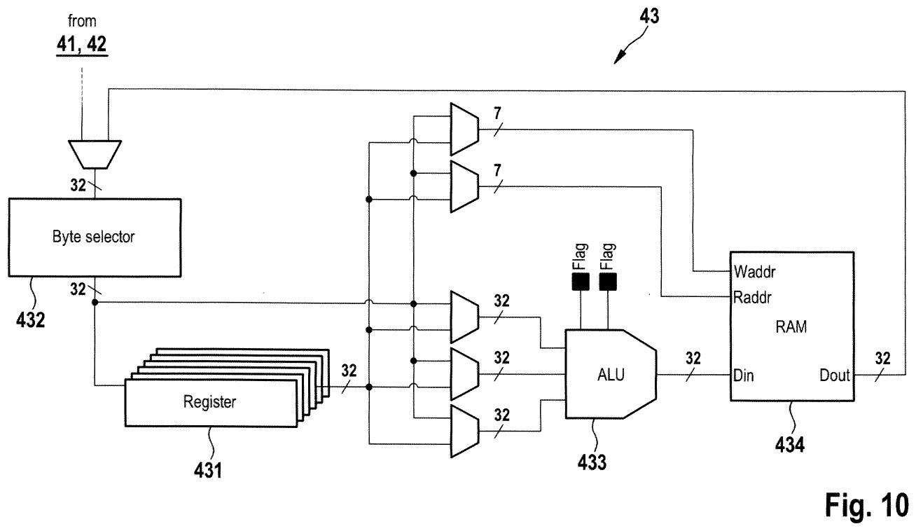

As shown in FIG. 10, a processing block 43 comprises a number of general purpose registers 431, a byte selector block 432, an ALU 433, and RAM 434. The input of processing block 43 connects to the front end block 41, the timing block 42 and neighboring processing cores through a set of multiplexers managed by control block 44. The output is the RAM memory itself that can be read out of the processing core 31 by external system circuitry or a set of registers that connect to the neighboring processing cores 31.

The general purpose registers 431 can be loaded with data coming from the input, the ALU 433 or RAM 434. The load signals for the general purpose registers 431 are independently driven by the control block 44 to enable writing of the same data into multiple locations simultaneously if required.

The byte selector block 432 is a specialized circuit used to shift or extract specific bytes from the data word presented at its input. It can be used either by itself with a specialized instruction or in combination with other operations. Following table summarizes the manipulations that the byte selector block 432 can perform:

| Function | # | Output Effect |
|---|---|---|
| 1 | I[31:0] | No operation |
| 2 | I[7:0] | Byte 0 |
| 3 | I[15:8] | Byte 1 |
| 4 | I[23:16] | Byte 2 |
| 5 | I[31:24] | Byte 3 |
| 6 | I[15:0] | Lower half |
| 7 | I[31:16] | Upper half |
| 8 | I[0:31] | Inverted bit order |

The ALU 433 is a combinatorial circuit block with three inputs and a single output of the same bit size. An ALU control signal selects CALU which one of the 25 possible operations is used to compute the output. Following operations may be performed: NOT O=NOT Ain, AND O=Ain AND Bin, OR O=Ain OR Bin, XOR O=Ain XOR Bin, NEG O=−Cin, ADD O=Ain+Cin, SUB O=Ain−Cin, MUL O=Ain×Bin, MAC O=Ain×Bin+Cin, CMP Ain<Bin, RL O=Ain[30:0] & Ain[31], RR O=Ain[0] & Ain[31:1], SL O=Ain<<1, SR O=Ain>>1, MAX O=max (Ain, Bin), and MIN O=min (Ain, Bin).

In addition to the integer output, the ALU 433 also generates two flags used for conditional jumps or instruction calls: the Zero and the Carry. Depending on the result of the arithmetic operation, these flags are either set or cleared and remain in the same state until another operation acts on them. As an exception, none of the logic operations influence the Carry flag.

The inputs Ain, Bin, Cin to the ALU can be provided from multiple sources, either from the general purpose registers 432, an explicit RAM address, a pointer to a RAM address or a hard coded value in the instruction code. Similarly, the operation result can be written to a register or an explicit or pointed RAM location.

The memory may be a dual port RAM block. The read and write address ports are independently controlled in order to allow the data sourcing flexibility described previously. In addition, the RAM can be accessed externally by overriding all the connections, a feature used for debugging and extracting the processor outputs.

The control block 44 comprises an instruction memory 441 formed as a ROM, an instruction decoder circuit 442 and a finite state machine 443. A 1 bit synchronization signal from each of the neighbouring processing cores 31 can be used at runtime for conditional instructions. Similarly, a 1 bit output signal is connected to each of the neighbouring processing cores 31 and can be either strobed or set through software. In addition, two 1 bit inputs and a 1 bit output that can be operated in the same fashion as the connections to the neighbouring processing cores 31 are present and are designed for synchronization with modules external to the device.

The instruction memory 441 may be a 256×24 bit dual port RAM block. In contrast to the scratchpad RAM from the processing block 43, only the read port of the instruction memory 441 can be accessed by the processing core 31 and as a result it acts like a ROM. The write port may be connected to the device bus and is only used during setup or in special cases where program execution is suspended and the instruction memory 441 may be rewritten at runtime.

The processing cores 31 may be configured to follow a fetch-decode-execute sequence that takes exactly 3 clock cycles for every instruction. During the fetch stage, the instruction pointed to by the program counter register (PC) is read from the ROM 441 and passed to the instruction decoder 442, a combinatorial circuit that drives all the processing core control signals. At the decode stage, in addition to setting the control signals, data that is needed from the RAM is fetched, either by directly driving the RAM address bus or by using a general purpose register as a pointer. At the end of the final stage, the operation result is written to the requested destination and the PC is incremented.

Each instruction may be 24 bits long and starts with a variable length opcode followed by the payload.

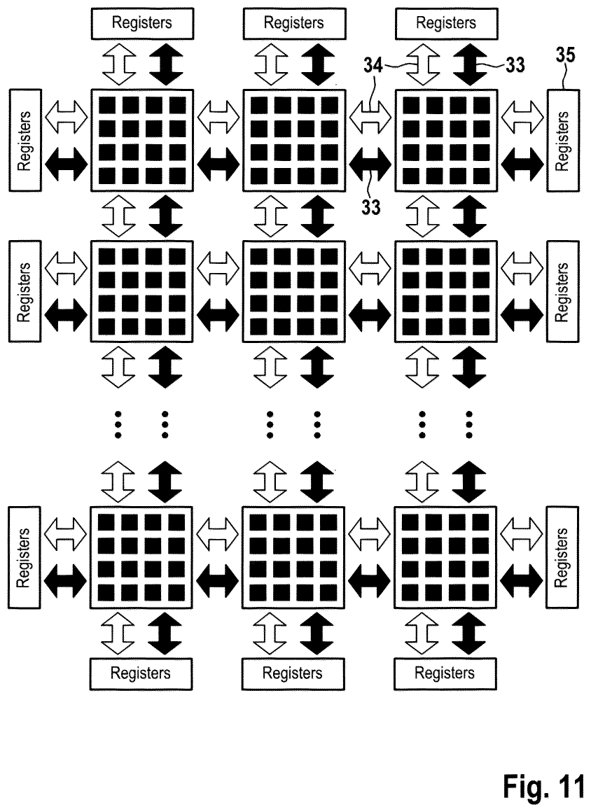

The architecture of the imaging sensor device comprises a number of processing cores 31 arranged in grid such as a 6×3 grid in the present example as shown in FIG. 11. Each processing core 31 is connected to its four direct neighboring processing cores 31 through a bidirectional data bus 33 and a bidirectional timing signal line 34. In case one or more neighbors are missing (for edge cores), the corresponding signals may be connected to a register 35.

Programming and readout of the device may be performed through a conventional AXI bus, wherein the outputs of each processing core 31 being mapped to memory locations which may include the instruction ROM, RAM and any accompanying registers when required.

Two input signals are distributed to all processing cores 31 and can reach each processing core 31 in parallel and can be used for synchronisation.

Programming of each processing core 31 may be performed by uploading the program into the individual instruction memory (ROM) 441 through the AXI bus. In order to avoid any unexpected behavior, the targeted processing core 31 should be kept in the reset state during this procedure. However, there may be provided two exceptions when a processing core 31 can be reprogrammed at runtime: if there is a certainty that the execution of a certain part of the program will not take place until reprogramming has finished or if the processing core 31 is kept frozen waiting for an external stimulus using the special purpose WAIT instruction.

The instruction types can be classified into 5 categories: logic, arithmetic, manipulation, flow and special. The majority of instructions have multiple variants depending on the source of the operands and the destination of the result.

Logic instructions can have one or two operands sourced from either a register or a RAM location. The result can be written to any register or RAM location, including one that acted as a source. This type of operation does not support explicit operands. After execution, the ALU carry flag will be cleared regardless of the result, these instructions replace a dedicated clear flag command. The ALU zero flag functions as normal. The four logical operations supported by the architecture are: NOT, AND, OR, and XOR.

Arithmetic instructions can be performed by the ALU: sign inversion, addition, subtraction, multiplication, MAC, MAX, MIN, and value comparison. Similarly, to the logical instructions, they can act on data from the general purpose registers or the RAM, but can also use three operands (MAC instruction) or explicit values (ADD and SUB instructions).

Manipulation instructions act on a single operand and are used to apply rotations and shifts or select specific bytes. The category also contains the RAM STORE and FETCH instructions that transfer data from a general purpose register 432 to the RAM or in reverse, the latter option supporting multiple destinations at the same time. In addition, a LOAD instruction is provided to write an explicit value to any of the general purpose registers 432.

Flow instructions influence the execution of the program by changing the PC register. The JUMP instruction can be used to jump to any address in the instruction memory either unconditionally or depending on the status of the available flags. The CALL and RET instructions may be used to execute subroutines. The former acts exactly like the JUMP instruction and its variants but will push the PC value to the stack so that when RET is called program execution can resume from the same point.

The highly customized architecture requires a special set of instructions that are not normally encountered with other CPUs. Communication with the neighboring processing cores 31 and the external circuits may be done through the SAVEN, GETN, PUTN, and TELL instructions. The first two are used to sample the neighbor data bus and transfer the value to the general purpose registers 432. Both instructions support multiple sources and destinations at the same time. The PUTN instruction will latch the value from a general purpose register onto one or multiple neighbor data buses. Finally, TELL is used to strobe or set synchronization signals for the neighboring control units or the external IO pads.

Data from the timing module or the front end can be read using dedicated GETC and GETP instructions that support simultaneous byte selection and multiple destinations.

All the combinational logic paths have their own configuration instructions, starting with the front end multiplexers (SETFM, SETTM) and the LUT functionality (SETLUT) and ending with the fast path OR tree (SETOR) and timing module (SETTIME).

Finally, a special WAIT instruction may be provided to facilitate the simultaneous synchronization of the cores with an asynchronous external trigger condition. When running this instruction, the control block 44 is frozen in the execute stage until the specified condition is met, after which operation resumes immediately, at the next clock cycle. The condition is verified by monitoring the neighboring processing cores 31 and external synchronization signals and is only met when a pulse has been detected from all of the requested sources, regardless of order.

As a possible application, an LSTM Lidar sensor is described. A long short-term memory (LSTM) is a special type of artificial neural network that contains feedback connections which allow the processing of data sequences such as audio or video signals. Recently, research has focused in extending the use of LSTM to LiDAR applications, where the data stream generated by the time of flight (ToF) image sensor is processed by such a network to determine the depth map of the detected scene. The unique characteristics of above architecture allows implementing an LSTM as the processing cores 31 can share information between them which allows for a high degree of parallelization and as the reconfigurable front end block 41 can implement preprocessing techniques such as coincidence detection with no speed or processing penalty.

As an example, an imaging sensor is proposed which acts as a single point ToF detector used in an X-Y scanning setup and which implements an LSTM cell of size 20. The front end block 41 is configured to trigger the timing block 42 with the first detected input pulse within an exposure window (any of the 4×4 pixel segments, or just one pixel segment, or a trigger when at least a number of pixels from the 4×4 pixel segment have fired).

The following equations describe the LSTM at time step t:

$$\begin{matrix}{g}_{f} = σ ( {W}_{f} \times x [ t ] ‖ h [ t - 1 ] + {b}_{f} ) \\ {g}_{i 1} = σ ( {W}_{i 1} \times x [ t ] ‖ h [ t - 1 ] + {b}_{i 1} ) \\ {g}_{i 2} = tanh ( {W}_{i 2} \times x [ t ] ‖ h [ t - 1 ] + {b}_{i 2} ) \\ {g}_{o} = σ ( {W}_{o} \times x [ t ] ‖ h [ t - 1 ] + {b}_{o} ) \\ c [ t ] = {g}_{f} \cdot c [ t - 1 ] + {g}_{i 1} \cdot {g}_{i 2} \\ h [ t ] = {g}_{o} \cdot tanh ( c [ t ] )\end{matrix}$$

where g_{f}, gᵢ₁, gᵢ₂ and gₒ are 20×1 arrays of values for the forget, input, and output gates, h and c are 20×1 vectors representing the hidden and cell states that are saved from one LSTM iteration to the next, x is the input value given by the timing block, W_{f}, Wᵢ₁, Wᵢ₂ and Wₒ are 20×21 weight matrices and bᵣ, bᵢ₁, bᵢ₂ and bₒ are 20×1 bias arrays. All the W and b values are constant and determined before runtime during the training of the LSTM. σ and tanh are the sigmoid and hyperbolic tangent functions while ∥, x, and . represent the concatenation, matrix multiplication, and Hadamard multiplication, respectively.

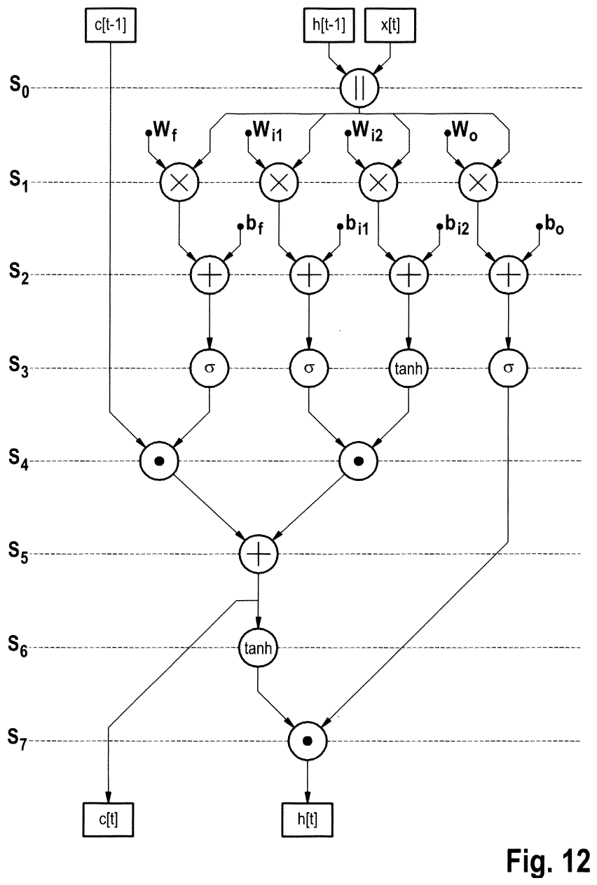

FIG. 12 presents the scheduled graph for above equations. Step S0 is trivial as the concatenation operation can be replaced by a memory write. Steps S1 and S2 are the most resource intensive, requiring a total of 420 fixed point MACs. Steps S4, S5 and S7 only require 40 fixed point multiplications and 20 fixed point additions/multiplications respectively. The nonlinear tanh and σ functions can be implemented as LUTs, i.e. simple memory read operations. In order to increase the execution speed, steps S1 and S2 are distributed across 4 separate slave cores, while the remaining steps are assigned to a single master core.

The total available RAM in each core is 512 bytes and as a result, all weight and bias coefficients had to be stored as 8-bit signed fixed point numbers with 3 fractional bits, 4 coefficients per RAM word. The g_{f}, gᵢ₁, gᵢ₂ and gₒ, h and c values have a 16-bit signed fixed-point representation with 3 fractional bits and are stored in pairs at each RAM location. The LUTs used for the nonlinear activation functions have the same data format as the previous variables.

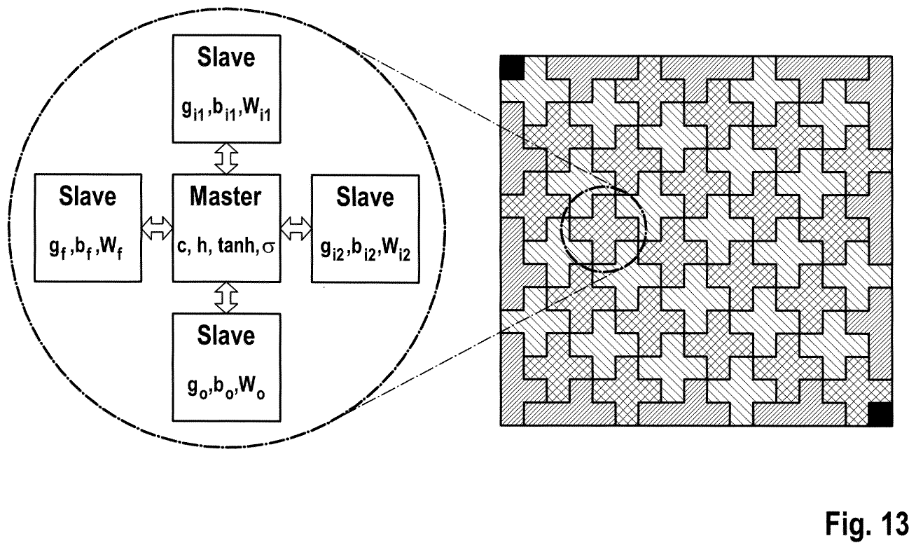

FIG. 13 shows the arrangement of the 5 processing cores 31 used for the LSTM implementation. The master processing core 31 is surrounded by the slave processing cores 31 in the four cardinal directions in order to allow the fastest data transfer possible. Once the master processing core 31 finishes the exposure period, it will transfer the x[t] variable to the four slaves and wait until all the matrix multiplications and additions are finalized. The master processing core 31 will then read the results and perform all of the remaining operations.

FIG. 13 shows a possible way of arranging the 5-core clusters in order to form a large format image. In this case, the clusters at the edges of the array have a different arrangement of processing cores 31 because of the geometric constraints. Two cores cannot be used and are represented by black squares. It must be noted that the current setup can be extended so that the master processing core 31 also performs the computations for the timestamps from its corresponding slave processing cores 31, essentially creating a uniform LSTM imager.

The processing cores 31 may also interoperate in a master-master configuration. For example: when an image shall be compressed by applying a function which includes looking up values in a lookup table using the current pixel values or TDC timestamps. Each processing core 31 would need a copy of this table, but in the majority of cases, the table will be too big to fit into each processing core 31, so instead, the table may be broken up into parts and distributed among all the processing cores 31. In this way, each processing core 31 may process its own input, but if that input is out of its range, it will send it to the neighboring processing cores 31 that stores the respective part of the table.

While any processing core can send data only to the neighboring to processing cores, data can be further transferred from the neighboring processing cores to their neighboring processing cores. In this way, information can be shared between any two cores, but indirectly and slower as there is no physical connection directly between the two.

1. Imaging sensor device in a stacked arrangement comprising:
a pixel array tier comprising a plurality of pixel segments each having a plurality of pixels for photon detection each providing a digital pixel output;
a processing tier comprising a number of processing cores each associated with one of the plurality of pixel segments to receive the pixel outputs of the pixels of the respective pixel segment, wherein the processing cores are each in bidirectional communication with one or more neighboring processing cores,
wherein the processing cores are each configured to receive pixel outputs of the pixels of the associated pixel segments and to distribute processing of pixel outputs between the processing core and the at least one of the neighboring processing cores.

2. Imaging sensor device according to claim 1, wherein the pixels of the pixel array tier comprises a detector diode, particularly an SPAD, and a preprocessing circuitry coupled with the detector diode to provide the respective pixel output as a signal, wherein particularly the signal is provided to the processing tier via through vias in the pixel array tier.

3. Imaging sensor device according to claim 1, wherein each processing core comprises a front end block that comprises a combinational logic and/or at least one lookup table which are freely configurable to provide masking and/or logical operations for the pixel output to preprocess the pixel outputs.

4. Imaging sensor device according to claim 3, wherein a timing block is configured to receive the preprocessed pixel outputs and to perform various timing functions such as pulse width and/or phase shift measurements.

5. Imaging sensor device according to claim 1, wherein a processing block is provided comprising a set of general purpose registers, an arithmetic and logic unit (ALU) and a RAM wherein a control block is provided to control the operation of the processing block.

6. Imaging sensor device according to claim 5, wherein the control block of at least one processing core associated with one respective pixel segment is configured to split one or more processing tasks to be performed on the pixels of that one pixel segment into processing parts, wherein at least two of the processing parts may be processed in parallel at a time, wherein the at least two processing parts are at least partly performed in parallel in the processing core and the at least one neighboring processing cores by directly controlling processing of the respective processing part in the processing block of the processing core and by instructing the at least one neighboring processing core to perform the other of the respective processing parts, respectively.

7. Imaging sensor device according claim 6, wherein the processing task includes matrix operations and/or addition operations performed on an image detected by the imaging sensor device, and particularly comprises a LSTM calculation which includes matrix operations, addition operations, sigmoid operations and tangens hyperbolicus operations, wherein the control blocks of each of the processing cores may each be configured:
to split the execution of the matrix operations and addition operations to be performed on the pixels of that one associated pixel segment into multiple processing parts, wherein at least two of the processing parts may be processed in parallel at a time;
to perform at least one of the processing parts in the respective control block, and
to communicate at least one of the multiple processing parts to at least one of the neighboring processing cores neighboring the respective processing core, and to instruct the at least one respective neighboring processing core to perform the respective at least one of the multiple processing parts.

8. Imaging sensor device according to claim 1, wherein the processing cores associated with a pixel segment at an edge of an pixel array are each in bidirectional communication with one or more registers.

9. Imaging sensor device according to claim 1, wherein the processing cores are each in bidirectional communication via a bidirectional data bus and a bidirectional timing signal line.

10. Imaging sensor device according to claim 1, wherein the processing tier and the pixel array tier are formed on separate substrates which are stacked to form the imaging sensor device.

11. Imaging sensor device according to claim 1, wherein a processing task is separated into processing parts wherein at least one of the processing cores is configured to distribute the processing parts among the at least one processing core and the at least one of the neighboring processing cores neighboring the at least one processing core.
